(19) United States
(12) Patent Application Publication
(10) Pub. No.: US 2002/0091972 A1
(43) Pub. Date: Jul. 11, 2002

(54) Method for predicting machine or process faults and automated system for implementing same

(76) Inventors: David P. Harris, Chicago, IL (US); Jerry J. Sychra, Downers Grove, IL (US); Lisa Schmit, Manhattan, IL (US); W. Karl Kuhrman, Evanston, IL (US)

Correspondence Address: LAFF, WHITESEL & SARET, LTD., 401 North Michigan Avenue, Suite 1700, Chicago, IL, 60611, US

(21) Appl. No.: 09/755,208

(22) Filed: Jan. 5, 2001

(51) Int. Cl. H02H 3/05

(52) U.S. Cl. 714/47

(57) ABSTRACT

A method for developing machine or process specific predictions of error codes and machine or processes events associated with the operation of one or more machines or processes is provided. The method involves a data set evaluation phase and a monitoring phase. The data set evaluation phase requires an analysis of historical operating data from said one or more machines or processes to identify significant precursor patterns associated with the occurrence of the error codes or events. The method next involves developing predictive models based on the application of one or more statistical tools and pattern recognition techniques whereby future occurrences of the error codes may be predicted within a defined time window from an analysis of the occurrences of significant precursor events within a data collection time window which precedes the prediction time window. Operating data, including the occurrences of the significant precursor events, are then collected during the data collection time window. The predictive model is applied to the data collected during the data collection window to generate predictions of the occurrence of the error codes within a predefined prediction time window.

### BACKGROUND OF THE INVENTION

The present invention provides a method for providing a non-intrusive solution to the problem of predicting when a machine or process will fail. Because of the complexity of the tasks performed by many of today's computer controlled machines and processes, equipment and process controllers often experience periodic errors and machine faults that can entirely shut down the operation of a machine or process. Operating errors may result from machine component failures, operator errors, environmental factors and other causes. In any event, unplanned shutdowns resulting from such periodic errors can have a very detrimental affect on the productivity of the machine or process in question.

Two approaches are generally followed in attempting minimize the adverse affects of such unplanned shutdowns. The first and most common approach is the “break and fix” mode. In this mode of operation, the machine or process is run at or near capacity until it breaks. When it does, repair crews fix whatever component has broken or otherwise clear the fault that has stopped the machine or process, and the machine or process is re-started and run until the next component failure or the next fault occurs. The second approach is the scheduled maintenance approach. In this mode, the equipment is shut down at regular scheduled intervals and various components which are subject to wear are replaced rather than waiting for them to fail during production. Other routine maintenance tasks, such as lubricating bearings, tightening belts, and so forth are usually taken care of at the same time.

Both the break and fix mode and the scheduled maintenance mode can be expensive both in terms of purchasing parts and materials, and also in terms of lost productivity. The scheduled maintenance mode has the advantage that parts can be ordered in advance, and shutdowns can be planned for and scheduled with less impact on inventories and production schedules. However, scheduled maintenance programs do not preclude break and fix events that may nonetheless occur between scheduled repairs. In order to avoid many of the costs involved in implementing scheduled maintenance programs and the even larger costs associated with unscheduled shutdowns, it is highly desirable to predict, with a high degree of accuracy, when machinery and equipment will either fail or experience operating faults that may result in extended unplanned shutdowns and lost productivity.

Most modern equipment, machinery and processes, ranging from automotive assembly lines to Automated Teller Machines (ATM), rely on computers to control their operation. A myriad of sensors and input operators record the operating conditions of the machines or processes and generate production reports and fault histories which may be used in developing preventive maintenance programs. However, even when fault histories and production reports are used in developing preventive maintenance programs, unnecessary expenditures and production delays may result from making repairs that may not actually be needed, or when parts fail or faults occur unexpectedly during production. If failures are predicted accurately, maintenance can be forestalled until it is actually necessary, and shutdowns can be planned for to reduce their impact on efficiency and productivity.

What is needed is a method for analyzing operating data from one or more machines or processes to develop a model that accurately predicts upcoming machine faults or component failures for each individual machine or process. Such a system must be sufficiently flexible to be applied to a wide range of machines or processes and must be adaptable to various operating conditions so that the lag time between when the event predictions are made and the time when the events are predicted to occur, as well as the size of the window within which the events are predicted to occur, can be varied to suit the needs of the equipment operator. An automated system is also needed for implementing a method of providing predictive maintenance. An automated system should periodically receive operating data from the machines and or processes being monitored and supply regularly scheduled prediction reports to the machine operator. These reports should contain the specific errors that will occur on each machine or process during the specified prediction window. Further, the automated system should be capable of testing the results of previous predictions and adjusting the mechanism for making the predictions when necessary in order to attain the highest prediction accuracy possible.

### SUMMARY OF THE INVENTION

The present invention relates to a method of performing predictive maintenance on one or more machines or processes. In a first aspect of the invention, historical operating data from the machines or processes are gathered. The collected historical operating data include the occurrence of significant operating events such as various sensor values, input and output data, the occurrence of various fault conditions, and the like. The collected historical operating data are then analyzed to determine whether having foreknowledge of the future occurrence of any significant operating event would prove valuable to the operator of the machine or process. If so, a program for predicting the occurrence of those significant events is implemented. The program for predicting the occurrence of significant events determines whether or not the targeted events will occur within a predefined prediction window based on historical operating data gathered during a data collection window which precedes the prediction window.

Another aspect of the present invention relates to a program for predicting the future occurrence of significant operating events on one or more machines or processes. Such a program is generally broken down into two phases. The first phase is the data set evaluation phase (DSE). The second phase is the monitoring and forecasting phase. The data set evaluation phase involves receiving a first set of historical operating data from the one or more machines or processes targeted for making predictions and performing rigorous research and analysis on the data. The goal of the DSE is to determine the best methods for generating predictions. Upon receiving the first set of historical data, the data are analyzed to determine whether the data meet prediction requirements. These requirements are:

1. activity data are available (when the machine was in use), time stamped and machine identified;

2. error code data are available, time stamped and machine identified;

3. data are continuous over specific time intervals (no long time gaps, excluding specific off days or hours, weekends, holidays etc.); and

4. there are sufficient data streams for prediction.

The collected historical data are then conditioned and organized to fit the data formats required for further analysis. Predictive models are then created based on the analysis of the first set of historical operating data. The end result of the DSE is individual predictive models for each error or fault code to be predicted on each machine or process. The predictive models are configured such that when they are applied to future sets of historical operating data they will predict whether and when the various significant events will occur within a specified prediction window on individual machines or processes.

Once the predictive models have been established, the monitoring phase begins. Operating data are collected from the targeted one or more machines or processes on an established schedule. The predictive models are then applied to the new sets of historical operating data. Prediction reports are generated detailing which errors will occur during successive prediction windows. The prediction reports identify the particular machines or processes on which the errors will occur, and specify the times at which the errors are predicted to occur. Successive operational data sets are collected and the predictive models applied thereto to make further predictions in succeeding prediction windows and to check the accuracy of previously made predictions. If the prediction accuracy falls below a desired threshold, the data set evaluation phase may be repeated in order to create a more accurate prediction model.

### BRIEF DESCRIPTION OF THE DRAWINGS

FIG. 1 is a flow chart showing an overview of the method of the present invention;

FIG. 2 is a flow chart showing the data set evaluation (DSE) phase of the method of the present invention;

FIG. 3 is a flow chart showing the monitoring phase of the method of the present invention;

FIGS. 4a and 4b are the components of a flow chart of an automated system for implementing the monitoring phase of the present invention;

FIG. 5 is a first abbreviated set of a raw data from a machine on which the present invention was applied during a proof concept experiment;

FIG. 6 is an abbreviated operational data set wherein the relevant data has been extracted from the raw data;

FIG. 7 is an abbreviated operational data set after data conditioning; and

FIG. 8 is a multiple event prediction report (MEP) along with the tabulated results of the predictions contained therein.

### DETAILED DESCRIPTION OF THE INVENTION

The present invention provides a method for predicting when individual machines, equipment or processes will fail or experience significant errors or faults. The inventive method may be applied to a single stand-alone machine or process, or may be applied to a plurality of like machines or processes. In the course of practicing the method, predictive models are created for predicting when specific errors will occur on individual machines. Thus, although the method may be practiced across a large number of machines, and/or processes, in the interest of clarity the method will be described throughout the remainder of this specification as being applied only to a single machine. Those skilled in the art will recognize that the data gathering and analysis required for implementing the method on a single machine may be extended to additional like machines or may be similarly applied to a computer controlled process or processes. Further, the steps of analyzing historical operating data and preparing predictive models for a first machine population outlined below may be applied to a second machine population in an attempt to predict first time catastrophic failures. In general, error codes must occur in a machine's historical operating data before their recurrence can be accurately predicted in the future. However, by applying predictive models developed from a first machine population wherein a particular catastrophic failure has occurred to a second population of like machines, it is possible to predict the occurrence of the catastrophic failure in the second population. However, because the precursor events that precede such a failure may differ from machine to machine, prediction accuracy is reduced when predictive models are extrapolated from one machine population to another.

According to the method of the present invention, historical operating data from a machine are analyzed to identify features and events monitored by the machine's control system or other monitoring equipment. Operating data may consist of machine activity logs, error code logs, sensor logs and service history logs. Activity logs may include, among other things, information on when and how the machine was used, or other data concerning the operation of the machine such as operating speeds, production rates, and the like. Error code logs will generally contain information on when the machine experienced specific predefined errors and faults. Sensor logs may include information gathered from sensors on the machine or installed in the machine's environment to provide further information on the machine's conditions. Service history logs may include, among other things, information regarding the servicing of the machine and preventive maintenance measures performed on the machine. Operating data may also include data recorded from sources other than the machine itself, such as environmental logs.

Pattern recognition techniques are applied to the data for discovering patterns and associations in the occurrence of events within the operating data. These patterns and associations may then be employed to analyze future data sets in order to predict the occurrence of future events. As used herein, a feature relates to a specific operational state of a machine or component of a machine. Each feature includes a consistent descriptor, such as temperature, pressure, speed, color, or any other quantity that may be measured and recorded. In general each feature will have a discrete or continuous value that is likely to change over time. Each feature is unique and bears a unique descriptor. An example of such a feature might be “Press #1 Hydraulic Overload Pressure” which is measured by a pressure sensor located on a press identified as Press #1.

An event, for purposes of applying the method of the present invention, is any data point along a curve representing the measured value of a feature. In addition to the value of the feature, an event is further defined by the time at which the value is recorded. Continuing with the example above, an event might be described as an hydraulic overload pressure of 150 psi at 10:02 on Thursday September 17, or “Press #1, Hyd. O/L Press. 150 psi 10:02 A.M. Sep. 17, 2001.”

An “error code” may be defined as any event having a discrete value subject to some arbitrary criteria. Extending the press hydraulic overload example still further, an error code may be created and reported any time the hydraulic overload pressure exceeds some preset limit, such as 200 psi. This represents an undesirable condition which may stop the machine or process or otherwise interfere with production or create an unsafe condition.

Clearly, knowing in advance when an error code will occur is a great advantage to the operator of the equipment. Such knowledge allows steps to be taken to avert the conditions that lead to the occurrence of the error code, or at least prepare for its occurrence so that the consequences of the error code occurring can be minimized. The method of the present invention generates a multiple event prediction report (MEP) which predicts when various pre-selected error codes will occur on the machine. The MEP will generally cover a block of time such as one day, one week, or one month. Whatever time interval selected, the period covered by a MEP is referred to as the prediction window. The MEP predicts the occurrence (and non-occurrence) of error codes within the prediction window. Not only does the MEP predict which error codes will occur within the prediction window, but may also predict when the error codes will occur within the prediction window. For example, the MEP may include an entry which states that “Error Code 12: Hydraulic Overload Fault” will occur between 1:00 p.m. and 3:00 p.m. on Thursday of the week covered by the MEP. The narrow band of time in which the error code is actually predicted to occur, i.e. the two-hour period between 1:00 p.m. and 3:00 p.m. on Thursday, is referred to as the prediction resolution. The interim period between when the MEP containing the error code prediction is issued, and the actual time when the error code is predicted to occur is known as the forecast window. In order to maximize the usefulness of the predictions it is desirable to extend the forecast window and narrow the prediction resolution as much as possible while maintaining the desired prediction accuracy. In other words, it is most valuable to know as far in advance as possible exactly when an error code will occur with as much precision as possible.

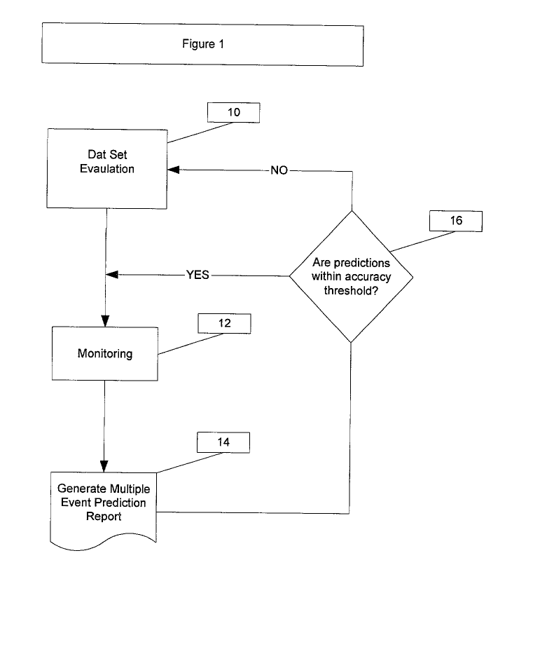

An overview of the method of the present invention is shown in the flow chart of FIG. 1. The method may be generally characterized as comprising two distinct phases corresponding to blocks 10 and 12 of the flow chart. During a Data Set Evaluation phase (DSE) 10, historical operating data are gathered from the machine on which predictions of the future occurrences of error codes are to be made. The data gathered for the DSE phase will in most cases comprise all of the operating data recorded by the machine's computer control system, however, external data recorded by other sources may also be included. In most cases, the error codes to be predicted will be identified or defined by the machine operator in advance of the DSE phase. These will often be limited to various abnormal or extreme operating conditions which are logged as machine faults by the machine's computerized control system. However, in some cases the DSE phase may include a data mapping function in which trends, associations, and other patterns may be identified during the DSE which indicate that predicting the occurrence of other events may also prove advantageous to the operator of the machine. Thus, additional error codes may be defined during the DSE phase.

Once it has been established which error codes are to be predicted, it is possible to discern individual events and patterns of events in the various data streams which are observable precursors to the occurrence of the various error codes. Initially the event codes that appear to be the most promising for having predictive value may be selected manually and subjected to standard predictive methods. However, other associations between various events and patterns of events to the occurrence of various error codes may not be readily apparent. Therefore, both manual and computerized data mining and pattern recognition techniques are applied. By a selective combination of various tools, a unified solution is provided which integrates one or more methodologies, such as statistical analysis, regression trees, hierarchical classifiers, discriminant analysis, classical pattern recognition, signal analysis, artificial neural networks, genetic classification algorithms, K-NN classifiers, principal component/factor analysis, optimization methods, and other techniques known to those skilled in the art.

The unified solution developed in the DSE phase concludes with the development of a predictive model for each of the error codes to be predicted. The predictive model will comprise one or more of the statistical analysis tools and/or algorithms listed above or others known to those skilled in the art. In developing the predictive models, subsets of features, defined as classifiers, are selected and tested with the various analytical tools to determine their efficacy as predictors. After several iterations of testing classifiers, applying different analytical tools, and combining classifier and tools, a unified solution is developed which represents the most accurate predictive model for each error code.

The particular statistical tools and/or algorithms which are best suited for use in the statistical models for predicting each error code on each machine or process will vary from one type of machine or process to another. The determination of which tools and/or algorithms are best suited for predicting the particular error codes selected for a particular machine or process is the primary task of the DSE phase of the predictive method of the present invention.

Once the predictive model has been created, the DSE phase is essentially complete and the method progresses to the monitoring phase as shown in block 12. During the monitoring phase, sets of historical operating data are gathered from the machine control system on a regular basis (i.e. daily, weekly, monthly, etc.) In most cases the sets of historical operating data will be collected during a time period equal to and immediately preceding the time period covered by the prediction window. For example, for a one-week prediction window, historical operating data will be collected during the week prior to the prediction window. Alternatively, a short lag time may be provided between the end of the data collection window and the prediction window. In another alternative, rolling data collection and prediction windows may be provided. In this scenario, again assuming a one-week prediction window, data are collected during the first seven days in order to make predictions for days 8-14. Thereafter, data from days 2-9 may be used to make predictions for days 9-15 and so forth. Regardless of the protocol established for gathering the data sets, data sets are analyzed according to the predictive model and as shown at block 14, and a multiple event prediction report (MEP) is generated for the subsequent prediction window. The MEP lists the error codes predicted to occur within the prediction window and indicate which error codes will occur. The MEP is the primary output of the method of the present invention.

Because the data collection and monitoring functions are ongoing, it is possible to check the accuracy of predictions made in a prior MEP against actual machine data collected from the current operating period. This check is represented as test point 16 in the flow chart of FIG. 1. If the predictions contained in the MEP are accurate within a preset accuracy threshold, such as 95% or some other value, the method returns to block 12 where the monitoring phase continues. If, on the other hand, the prediction accuracy drops below the preset accuracy threshold, the method returns to the DSE phase where accumulated sets of operating data are re-examined and adjustments are made to the prediction model as necessary to improve the prediction accuracy. It should be noted that the prediction accuracy includes error codes that do not occur when they are predicted, as well as the occurrence of error codes that were not predicted.

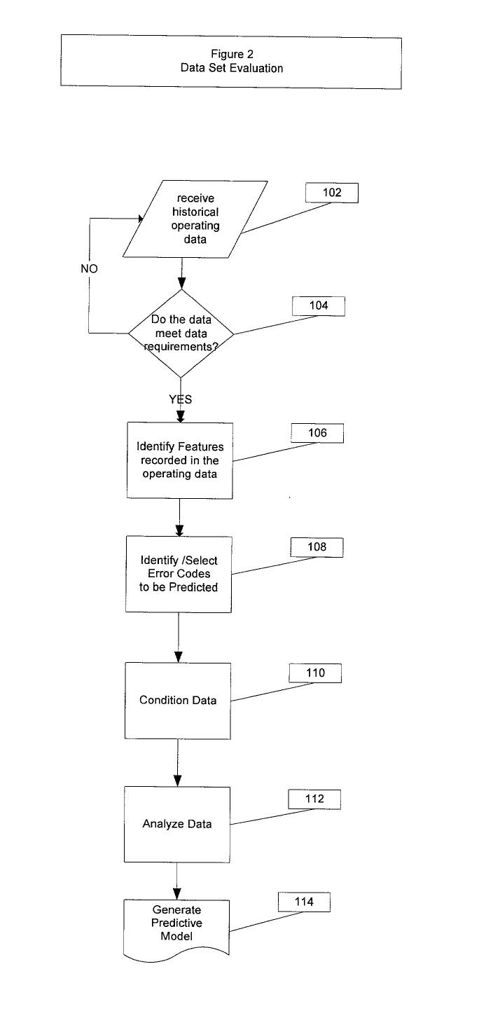

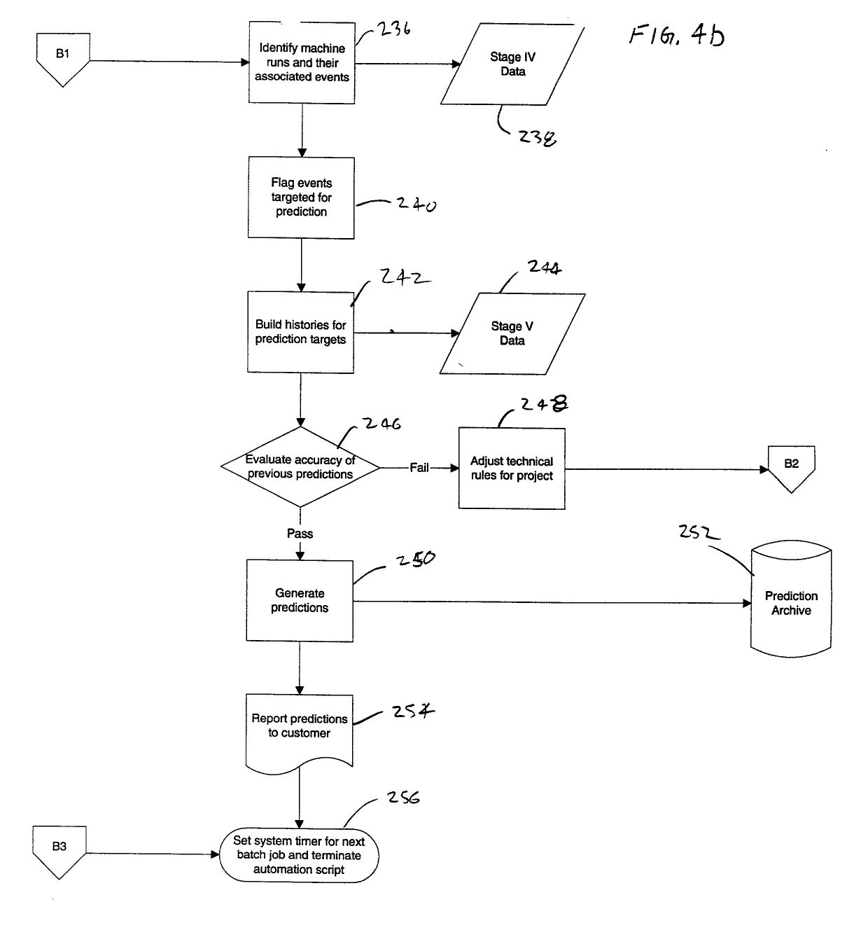

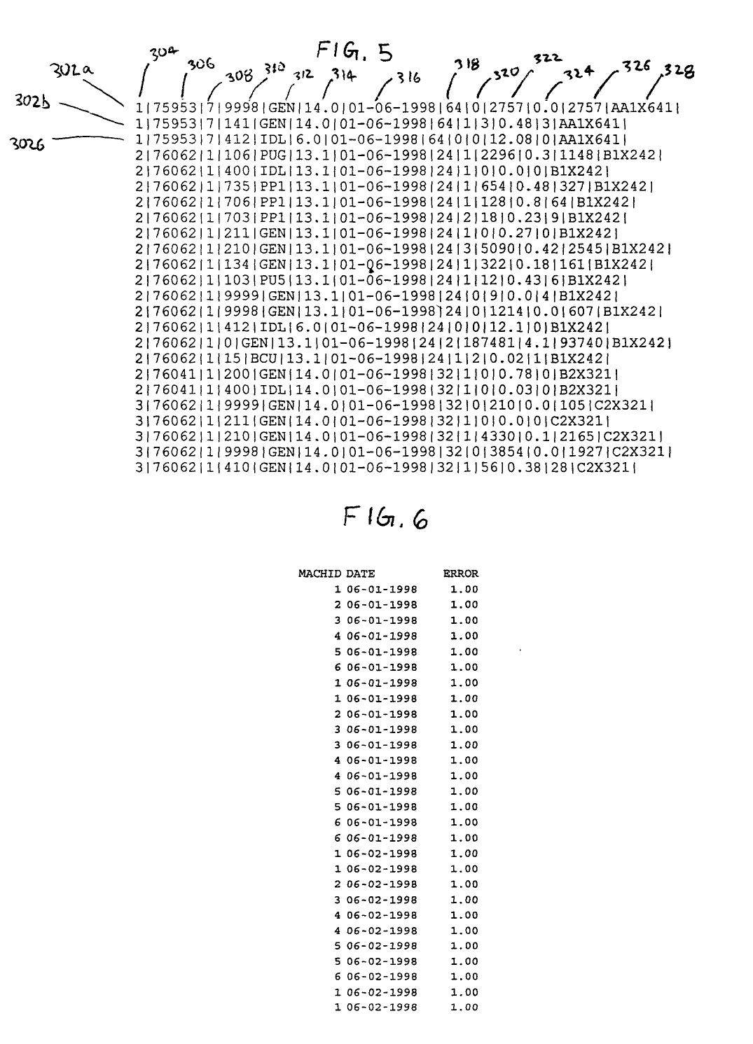

A more detailed flow chart of the DSE phase of the present inventive method is shown in FIG. 2. First, at block 102 historical operating data are received from the machine on which future error codes are to be predicted. An abbreviated sample of the type of data that might be received is shown in FIG. 5. Upon receiving the first set of historical data, the data are analyzed to determine whether the data meet prediction requirements 104. Events that have been previously defined as error codes or that represent abnormal operating conditions which it may be desirable to define as error codes, are included among the raw historical data. In order to ensure that a proper and accurate prediction model may be established, it is necessary that the received raw historical data be sufficiently voluminous that each error code, as well as precursor events associated with the occurrences of the error codes, occur with sufficient frequency to allow the operating conditions, input sequences, and event patterns which lead to the occurrences of the error codes to be recognized.

Next, at block 106 the features and events contained within the data are identified. If the error codes to be predicted have not been established ahead of time the error codes can be defined based on extreme operating conditions or rapid transitions in the values of various recorded machine features, as indicated at block 108. For example, a rapidly rising bearing temperature or a sudden loss of pressure in a key pneumatic system can be defined as an error code based on their occurrence in the received raw data set. Once the events recorded in the data have been identified and the error codes defined, the data are conditioned to fit the specific format necessary for analysis 110. After conditioning, data are analyzed using the various data mining, artificial intelligence and pattern recognition techniques described above and as indicated at block 10 112 The data analysis is performed to identify and correlate patterns of events that lead to the occurrence of the various error codes.

Finally, a predictive model is developed in block 11 4 comprising the various statistical analysis techniques and predictive algorithms which have been determined to provide the most accurate predictions for each error code being predicted. An individual predictive model is provided for each error code. The predictive models may then be applied to future sets of received data. As has been noted above, the specific techniques and algorithms that will comprise the predictive models will vary from error code to error code and between one type of target machine to another. However, techniques and algorithms that have been employed in test applications of the present inventive method with high degrees of success include: statistical analysis, regression trees, hierarchical classifiers, discriminant analysis, classical pattern recognition, signal analysis, artificial neural networks, genetic classification algorithms, K-NN classifiers, principal component/factor analysis, optimization methods, and other techniques. Once the predictive models have been created, the monitoring phase may begin.

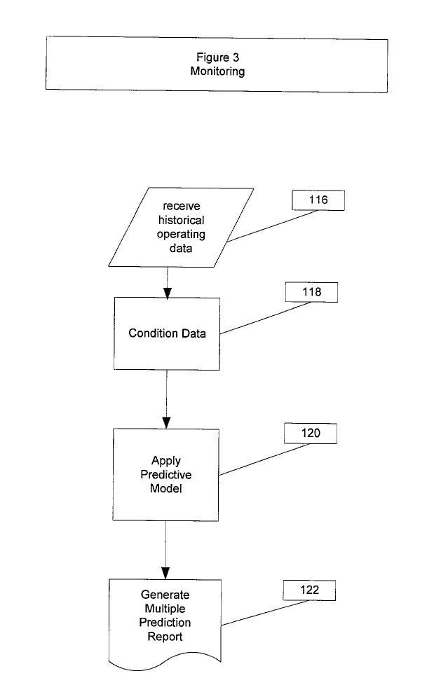

The monitoring phase of the present invention is set forth in FIG. 3 and involves gathering operating data from the target machine or process 112 on a periodic basis, conditioning the data 114 so that the predictive model may be applied to the conditioned data, applying the predictive model 116, and producing a report 118 of the error codes predicted to occur on each machine within a prediction window. In advanced applications of the inventive method it is also possible to determine a specific range of times within the prediction window when the error codes are likely to occur.

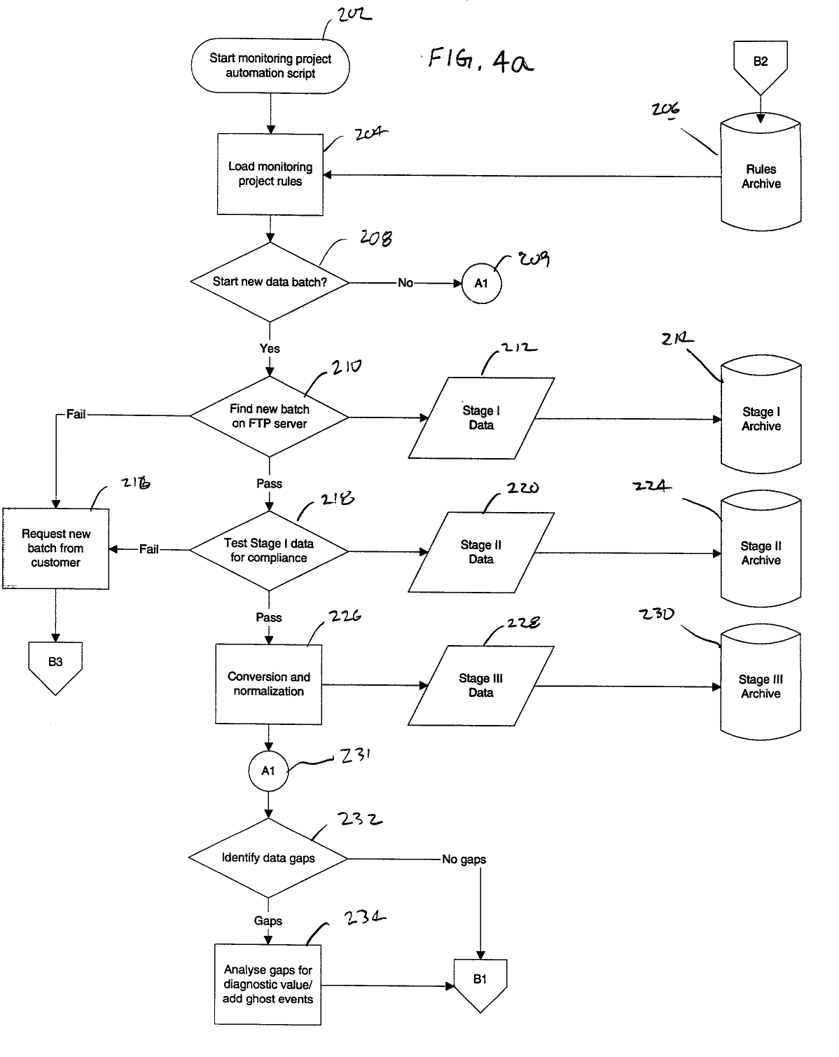

An embodiment of the invention, including an automated system for carrying out the monitoring phase of the inventive method is shown in FIGS. 4a and 4b. Employing this system, the operation of the target machine can be continually monitored on an ongoing basis. Error codes can be predicted well in advance of their actual occurrence so that proper steps can be taken to prepare for their occurrence, or to avoid them altogether. The monitoring phase begins at block 202 when a monitoring project automation script is executed. At block 204 the monitoring project rules are loaded from a rules archive 206. The monitoring project rules include the predictive model established at the conclusion of the DSE phase of the predictive maintenance project. At test point 208 it is determined whether the system is to monitor a new data set or a data set that has already been received. If a previously received data set is to be monitored the process jumps to a point 231 further ahead in the process, bypassing a number of data conditioning steps designed to convert newly received raw data sets into a format that may be input to and manipulated by the predictive model. Conversely, if it is determined at test point 208 that a new data set is to be processed, data conditioning commences beginning with decision block 210.

According to this automated embodiment of the monitoring phase of the inventive method, the target machine posts each new data set on a File Transfer Protocol (FTP) server. At test point block 210, the monitoring system attempts to access a new data set on the FTP server. If the system fails in locating the new data set, the system sends a request for new data to the operator of the target machine at block 216. If the new data are found, the system retrieves the new data set and stores the data as Stage I Data 212 in Stage I Data archive 214. The process then advances to test point 218 where the received data set is tested for compliance with pre-established rules regarding the format and content of the data sets. The data format rules will vary for each predictive model and will include factors such as non-reporting sensors, or holes in data and the like. If the data set does not meet the compliance requirements a new set is requested at block 216. If it is determined, at test point 218 that the data set does in fact meet compliance requirements, Stage II Data 220 is stored in a Stage II Data archive 224, and the method advances to the conversion and normalization function as shown in block 226. At this point, only that data of particular interest to the process is extracted from the files in the customer supplied data set. The rules for this extraction are stored in a database and represent a one-to-one mapping of the data fields in the customer files and the corresponding fields in the process database. The conversion and normalization step which prepares the data to be input to the various predictive models employed to predict error codes on the particular machine or process at hand will be unique for different machines and/or processes. Thus, the steps necessary to convert and normalize the data set will vary depending on the particular data set available from the machine that is being monitored and the particular format of the data required by the predictive models developed for that machine during the DSE phase. Once the data set has been conditioned, Stage III Data 228 is stored in a Stage III Data archive 230.

After conditioning and normalizing the data set, at test point 232 the Stage III Data is checked for gaps. Gaps may result if various events which are part of the normal data streams of the various error codes are missing from the data. For example, if a particular temperature sensor or pressure transducer is not reporting a value during a portion of the data collection window, and the output of the non-reporting transducer is a feature relied upon by the predictive model in predicting the occurrence of one or more error codes. If gaps in the data are found, the nature of each gap is analyzed at block 234. At Block 234 it is determined if the gaps are significant to predicting the occurrence of any error codes. If yes, ghost events may be substituted in the gaps. Ghost events may comprise average values of the feature measured near the time of the gap in the data, or values specified under normal operating conditions, and so forth. If no, gaps are found in the Stage III Data, or after the gaps have been filled at block 234, the process then moves on to block 236 shown at the top of FIG. 4b. Block 236 relates to instances where the method is being applied to multiple like machines. In that case the data is broken up into individual data streams for each machine. This data may be stored as Stage IV Data 238. Otherwise, if only a single machine is targeted for predictions, or after the step of separating the data streams from different machines is completed, the process moves to block 240 where the system flags those events and error codes targeted for prediction. Event histories for the targeted events are constructed at block 242, and the event histories are stored as Stage V Data 244. At test point 246, previously made predictions are compared to the event histories compiled at block 242. If the prediction accuracy falls below a predefined threshold adjustments are made to the technical rules for the monitoring project, including changes to the predictive models. If an adjustment is required, the new rules are stored in the Rules Archive 206, and the monitoring process is restarted from the beginning. If, however, the previous predictions meet the predefined prediction accuracy threshold, new predictions are generated at block 250 using the existing project rules and predictive models. The new predictions are stored in a Prediction Archive 252, and a prediction report or MEP is compiled at block 254. The MEP may be sent to the operator of the machine so that corrective actions may be taken. Following the generation of the prediction report, a timer is set for reinitiating the monitoring process after a fixed period of time after which a new data set will be made available for monitoring and the process repeats.

In an experimental proof of concept application of the predictive method of the present invention, operating data collected from a number of commercial grade printing presses were used to forecast various events related to the operation of the presses. The data obtained for the case study was obtained from secondary sources, namely, third party sensors installed on the presses rather than data obtained directly from the machines' control systems. The events recorded by the sensors were identified with an event code which was time stamped to indicate the date and time the event occurred.

The DSE evaluation phase of the test project involved the analysis of six months worth of operating data for six separate presses. After an initial analysis of the data, five event codes were targeted for prediction across the six machines. The project goal was to predict the occurrence of the five event codes within a seven day operating window.

The initial data were received in the format shown in FIG. 5. The data arrived in a plurality of records 302a, 302b, 302c, etc. The records shown in FIG. 5 are for illustrative purposes only, the actual number of records received for analyzing the operating of the machines was far in excess of what is shown in the figure. Each record 302 further included a number of fields 304-328, only some of which turned out to be relevant for making predictions. For this test application, error codes were predicted based on the patterns of occurrence of all error codes. For purposes of the test application, the machine I.D., the error code I.D. for each error code, and the date on which the error code occurred were the only relevant fields extracted from the raw data of FIG. 5 for further analysis and development of the predictive models. Thus, the raw data of FIG. 5 were reduced to the relatively simple format titled Data 1 shown in FIG. 6. In FIG. 6, each record comprises three data fields: machine I.D., date, and error code I.D. The data records shown in FIG. 6 are shown sorted first by error code, then date, then machine I.D. Again, only an abbreviated portion of the data file is shown. In the test application, a commercial statistical software program called SPSS was used to analyze the data. In order to run the SPSS software, it was first necessary to convert the data from the format shown in FIG. 6 to that shown in FIG. 7. FIG. 7 contains the same information as FIG. 5, except the different error codes are displayed in column format, and the records are sorted by machine I.D. and date. By looking at the first record in the file displayed in FIG. 7 it can be seen that on Jun. 1, 1998 machine number 1 experienced error code V1-1 three times, and error codes V3-1 and V6-1 once, and the remaining error codes did not occur that day. In addition to formatting the data for further analysis, the reformatting of the data evidenced in FIG. 7 is also typical of the data conditioning necessary to prepare data for applying the predictive model in the monitoring phase.

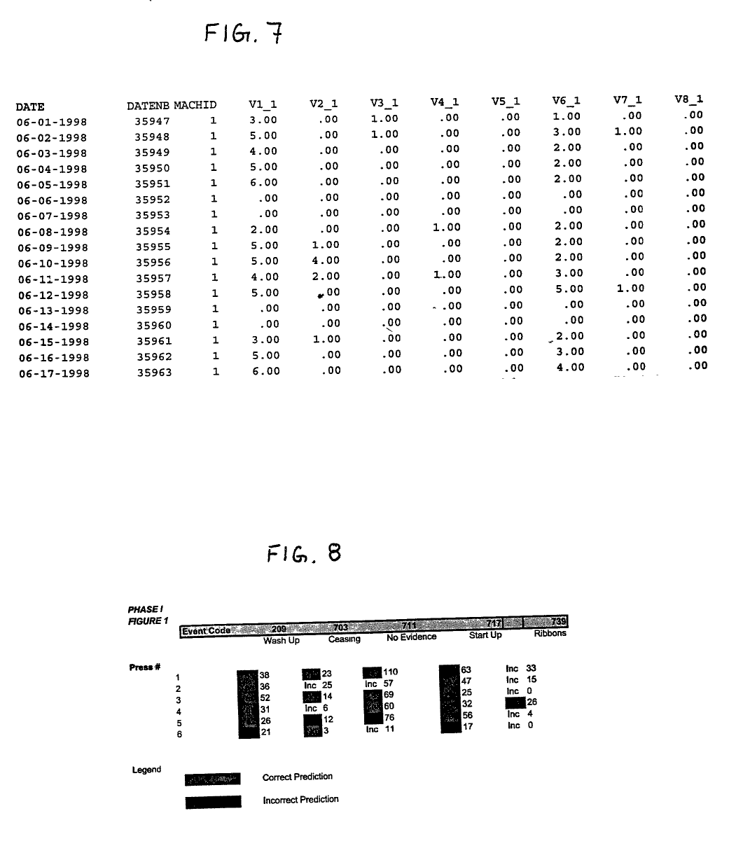

After analyzing the data using SPSS the predictive model selected for analyzing the data was an Auto-Regressive Integrated Moving Average model (ARIMA). Such a model is included in the commercial software package known as Decision Time, produced by SPSS, Inc. of Chicago, Ill. The predictive model was applied for each error code and for each machine. A portion of the resulting MEP is shown in FIG. 8. Because only historical data was used for the proof of concept, it was possible to immediately evaluate the predictions against further historical operating data corresponding to the prediction window. The results are also shown in FIG. 8. As can be seen, of 21 forecast made, 17 were predicted accurately, for a success rate of 81%. In additional trial applications using more and more refined techniques, and/or more inclusive data sets for the data set evaluation, forecast rates as high as 95% have been achieved.

It should be noted that various changes and modifications to the present invention may be made by those of ordinary skill in the art without departing from the spirit and scope of the present invention which is set out in more particular detail in the appended claims. Furthermore, those of ordinary skill in the art will appreciate that the foregoing description is by way of example only, and is not intended to be limiting of the invention as described in such appended claims.

What is claimed is:

1. A method of predicting the occurrence an event on a machine or process comprising the steps of:
receiving a first set of historical operating data from said machine or process, said first set of historical operating data including at least one occurrence of the significant event to be predicted;
creating a predictive model based on the first set of historical operating data such that when the predictive model is applied to future sets of historical operating data the predictive model will predict whether said significant event will occur within a specified prediction window;
receiving a second set of historical operating data from said machine, said second set of historical operating data covering a data collection period preceding the prediction window;
applying the predictive model to the second set of historical operating data to predict whether the significant event will occur during the prediction window.

2. The method of claim 1 further including the steps of:
receiving a third set of historical operating data covering a period of time corresponding to the prediction window;
comparing the times when the significant event occurred during the prediction window with the predicted occurrences of the significant event; and
revising the predictive model based on said comparison to improve the accuracy of future predictions.

3. The method of claim 1 wherein the predictive model is created to determine the time at which the significant event predicted to occur will occur within the prediction window.

4. The method of claim 3 further comprising the steps of collecting additional sets of historical operating data on a predetermined scheduled basis and applying the predictive model to each additional set of historical operating data to predict if and when the significant event will occur during subsequent prediction windows.

5. The method of claim 4 wherein the step of collecting the sets of historical operating data comprises an automatic set transfer of data from the machine over a computer network.

6. The method of claim 4 further comprising the step of conditioning the data contained in said sets of historical operating data to configure the data in a manner that can be operated on by the predictive model.

7. The method of claim 3 further comprising the step of generating a report indicating when the significant event is predicted to occur.

8. A process for predicting the occurrence of one or more machine error codes associated with the operation of one or more machines or processes, the method comprising the steps of:
analyzing historical operating data from said one or more machines or processes to identify significant precursor events associated with the occurrence of each said error code;
developing predictive models for each error code based on the application of one or more statistical tools and pattern recognition techniques whereby future occurrences of said error codes may be predicted within a defined prediction time window from an analysis of the occurrences of said significant precursor events within a data collection time window preceding the prediction time window;
collecting operating data, including the occurrence of said significant precursor events, during the data collection time window; and
applying the predictive models to the data collected to generate predictions of the occurrence of said error codes on said one or more machines or processes within the prediction time window.

9. The process of claim 8 wherein the step of developing a predictive model includes applying entropy based feature selection.

10. The process of claim 8 wherein the step of developing a predictive model includes applying discriminant analysis.

11. The process of claim 8 wherein the step of developing a predictive model includes applying K-NN classifiers.

12. The process of claim 8 wherein the step of developing a predictive model includes applying hierarchical classifiers.

13. The process of claim 8 wherein the step of developing a predictive model includes applying artificial neural networks.

14. The process of claim 8 wherein the step of developing a predictive model includes applying genetic classification algorithms.

15. The process of claim 8 wherein the step of developing a predictive model includes applying principal component/factor analysis.

16. The process of claim 8 wherein the step of developing a predictive model includes applying a n adaptive filter.

17. The process of claim 16 wherein the adaptive filter comprises a Kalman filter.

18. The method of claim 8 further comprising the step of conditioning the operating data collected from the one or more machine or processes, including extracting data relevant for making said predictions, and formatting the data in a manner compatible with the predictive model.

19. The method of claim 8 wherein the collection time window is approximately equal to the prediction time window.

20. A method of performing predictive maintenance on a machine or process, comprising the steps of:
receiving historical operating data from the machine or process, said historical operating data including the occurrence of significant operating events; analyzing the historical operating data to determine whether foreknowledge of the future occurrence of a significant operating event has value; and
implementing a program for predicting the occurrence of those significant events for which it has been determined that having foreknowledge of the future occurrence of the event has value within a predefined prediction window based on an historical operating data set gathered during a data collection window preceding the prediction window.

21. The method of claim 13 wherein the step of implementing a program comprises:
receiving sets of historical operating data from said machine or process on a regular basis, each set corresponding to a particular data collection window preceding a corresponding prediction window;
analyzing the data sets to determine whether data within the data sets indicate that an event for which foreknowledge of the future occurrence of the event adds value will occur during the corresponding prediction window.

22. The method of claim 14 wherein the step of analyzing the historical operating data sets comprises applying a predictive model for each significant event for which it has been determined that having foreknowledge of the future occurrence of the event has value to the data sets, and generating an event prediction report that indicates which events for which having foreknowledge of their future occurrence adds value will occur during the prediction window.

23. The method of claim 15 wherein the step of applying a predictive model to the data sets comprises applying one or more statistical analysis tools and pattern recognition techniques to the data within the data sets.

24. The method of claim 23 wherein the step of developing a predictive model includes applying entropy based feature selection.

25. The process of claim 23 wherein the step of developing a predictive model includes applying discriminant analysis.

26. The process of claim 23 wherein the step of developing a predictive model includes applying K-NN classifiers.

27. The process of claim 23 wherein the step of developing a predictive model includes applying hierarchical classifiers.

28. The process of claim 23 wherein the step of developing a predictive model includes applying artificial neural networks.

29. The process of claim 23 wherein the step of developing a predictive model includes applying genetic classification algorithms.

30. The process of claim 23 wherein the step of developing a predictive model includes applying principal component/factor analysis.

31. The process of claim 23 wherein the step of developing a predictive model includes applying an adaptive filter.

32. The process of claim 31 wherein the adaptive filter comprises a Kalman filter.
